(19) United States
(12) Patent Application Publication
(10) Pub. No.: US 2026/0302835 A1
(43) Pub. Date: Oct. 1, 2026

(54) WIRELESS POWER SUPPLY SYSTEM

(71) Applicant: TOYODA GOSEI CO., LTD., Kiyosu-shi (JP)

(72) Inventors: Tomokazu SAKAI, Kiyosu-shi (JP); Teppei ABE, Kiyosu-shi (JP)

(21) Appl. No.: 19/551,382

(22) Filed: Feb. 26, 2026

(30) Foreign Application Priority Data
Mar. 26, 2025 (JP) 2025-051906

(51) Int. Cl. H02J 50/20; H02J 50/90

(52) U.S. Cl. CPC H02J 50/20; H02J 50/90

(57) ABSTRACT

A wireless power supply system includes a power receiving device including a power receiving antenna unit that receives a power transfer signal, a rectifier unit that rectifies the power transfer signal into received power, a monitoring unit that monitors an intensity of the received power, a transmitting antenna unit that transmits an intensity signal related to the intensity of the received power, and a power reception control unit that controls the transmitting antenna unit based on a monitoring result of the monitoring unit to transmit the intensity signal, and a power transmitting device including a phase unit that adjusts a phase of the power transfer signal, a receiving antenna unit that receives the intensity signal, and a power transmission control unit that controls the phase unit based on the intensity signal and performs phase control of the power transfer signal so as to be optimal for the power receiving device.

### CROSS-REFERENCE TO RELATED APPLICATIONS

The present patent application claims the priority of Japanese patent application No. 2025/051906 filed on Mar. 26, 2025, and the entire contents of Japanese patent application No. 2025/051906 are hereby incorporated by reference.

### TECHNICAL FIELD

The present invention relates to a wireless power supply system.

### BACKGROUND ART

A wireless power transmission system is known which includes a power transmitter that transmits microwave energy and a power receiver that receives microwave energy (see, e.g., Patent Literature 1).

This power receiver has a motion detection mechanism such as an accelerometer, and when the motion detection mechanism detects that the power receiver is in motion, the power receiver outputs a signal to the power transmitter to, e.g., stop transmission of the microwave energy.

### CITATION LIST

### Patent Literature

Patent Literature 1: Japanese U.S. Pat. No. 6,125,471

### SUMMARY OF INVENTION

To optimize transmission of microwave energy in accordance with the power receiver in the wireless power transmission system, a motion detection mechanism must be added to the power receiver configuration, which causes a problem in that manufacturing costs increase.

It is an object of the invention to provide a wireless power supply system capable of optimizing a power transfer signal at low cost.

One aspect of the invention provides a wireless power supply system, comprising:
a power receiving device comprising a power receiving antenna unit that receives a power transfer signal, a rectifier unit that rectifies the power transfer signal into received power, a monitoring unit that monitors an intensity of the received power, a transmitting antenna unit that transmits an intensity signal related to the intensity of the received power, and a power reception control unit that controls the transmitting antenna unit based on a monitoring result of the monitoring unit to transmit the intensity signal; and
a power transmitting device comprising a power transmitting antenna unit that transmits the power transfer signal, a phase unit that adjusts a phase of the power transfer signal, a receiving antenna unit that receives the intensity signal, and a power transmission control unit that controls the phase unit based on the intensity signal and performs phase control of the power transfer signal so as to be optimal for the power receiving device.

### Advantageous Effects of Invention

According to an embodiment of the invention, it is possible to optimize the power transfer signal at low cost.

### BRIEF DESCRIPTION OF DRAWINGS

FIG. 1 is a diagram illustrating an example of a wireless power supply system in an embodiment.

FIG. 2 is an example block diagram illustrating the wireless power supply system in the embodiment.

FIG. 3 is a sequence diagram illustrating an example operation of the wireless power supply system in the embodiment.

### DESCRIPTION OF EMBODIMENTS

### Summary of the Embodiment

The wireless power supply system in the embodiment is generally composed of a power receiving device having a power receiving antenna unit that receives a power transfer signal, a rectifier unit that rectifies the power transfer signal into received power, a monitoring unit that monitors an intensity of the received power, a transmitting antenna unit that transmits an intensity signal related to the intensity of the received power, and a power reception control unit that controls the transmitting antenna unit based on a monitoring result of the monitoring unit to transmit the intensity signal; and a power transmitting device having a power transmitting antenna unit that transmits the power transfer signal, a phase unit that adjusts a phase of the power transfer signal, a receiving antenna unit that receives the intensity signal, and a power transmission control unit that controls the phase unit based on the intensity signal and performs phase control of the power transfer signal so as to be optimal for the power receiving device.

This wireless power supply system controls the phase based on the intensity of the received power, and thus can optimize the power transfer signal at lower cost than when this configuration is not adopted.

### EMBODIMENT

### General configuration of a wireless power supply system 1

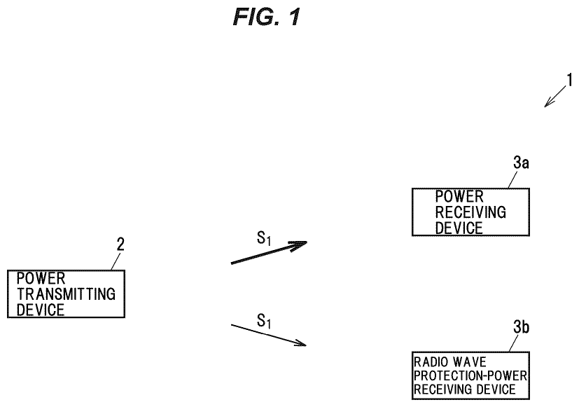

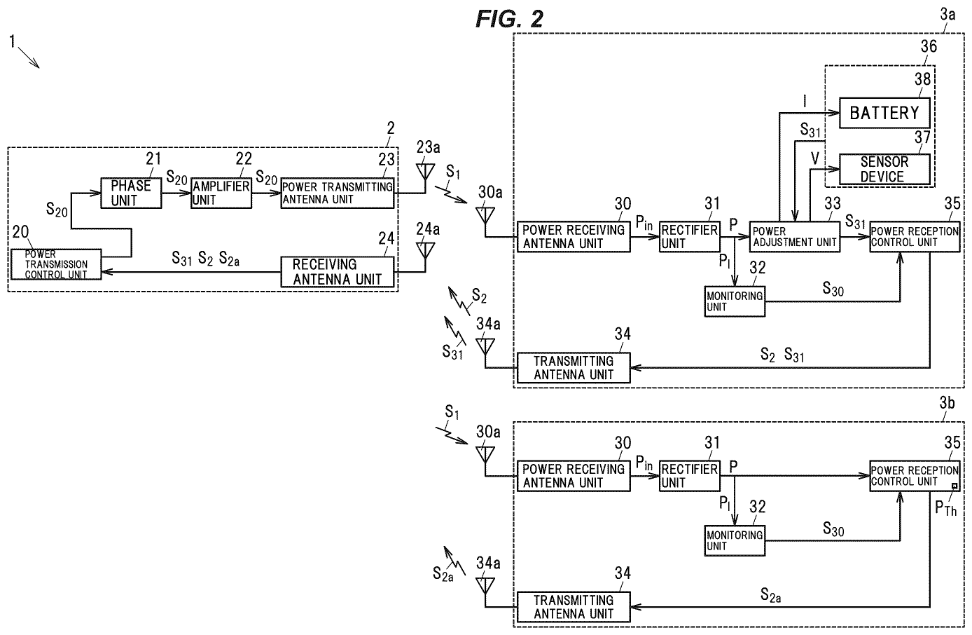

FIG. 1 is a diagram illustrating an example of a wireless power supply system in the embodiment. FIG. 2 is an example block diagram illustrating the wireless power supply system in the embodiment. In FIG. 2, flows of main signals and information are indicated by arrows. First, a general configuration of the wireless power supply system 1 will be described below.

As shown in FIG. 1, the wireless power supply system 1 is generally composed of a power transmitting device 2 and power receiving devices 3, as an example. The power receiving devices 3 are, e.g., a power receiving device 3a and a radio wave protection-power receiving device 3b. This radio wave protection-power receiving device 3b is placed on, e.g., a device or human body being an object to be protected that must be protected from a power transfer signal S₁. In this regard, there may be plural power receiving devices 3a and/or plural radio wave protection-power receiving devices 3.

In particular, as shown in FIG. 2, the wireless power supply system 1 is generally composed of the power receiving device 3 having a power receiving antenna unit 30 that receives the power transfer signal S₁, a rectifier unit 31 that rectifies the power transfer signal S₁ into received power P, a monitoring unit 32 that monitors an intensity P_{I} of the received power P, a transmitting antenna unit 34 that transmits an intensity signal S₂ related to the intensity P_{I} of the received power P, and a power reception control unit 35 that controls the transmitting antenna unit 34 based on a monitoring result of the monitoring unit 32 to transmit the intensity signal S₂; and the power transmitting device 2 having a power transmitting antenna unit 23 that transmits the power transfer signal S₁, a phase unit 21 that adjusts a phase of the power transfer signal S₁, a receiving antenna unit 24 that receives the intensity signal S₂, and a power transmission control unit 20 that controls the phase unit 21 based on the intensity signal S₂ and performs phase control of the power transfer signal S₁ so as to be optimal for the power receiving device 3, as an example.

The power transmitting device 2 performs optimization by repeatedly communicating with the power receiving device 3 and transmits an optimal power transfer signal S₁ to the power receiving device 3.

The power transfer signal S₁ and the intensity signal S₂ preferably have different frequencies. The power transfer signal S₁ has a frequency of 5.7 GHz as an example, but it is not limited thereto. The intensity signal S₂ has a frequency of 2.4 GHz as an example, but it is not limited thereto.

The power reception control unit 35 acquires device information S₃₁ related to electrically connected electronic devices 36 and transmits it through the transmitting antenna unit 34. The power transmission control unit 20 performs phase control of the power transfer signal S₁ so as to be optimal for the power receiving device 3, based on the device information S₃₁ received through the receiving antenna unit 24. The electronic devices 36 in the present embodiment are included in the power receiving device 3a, as shown in FIG. 2. Therefore, the power reception control unit 35 and the transmitting antenna unit 34 described above belong to the power receiving device 3a.

The electronic devices 36 are a sensor device 37 and a battery 38 as an example, but are not limited thereto. The sensor device 37 outputs, e.g., information about measured values, such as measured temperature or humidity, etc., as the device information S₃₁. The battery 38 outputs, e.g., information about the remaining battery capacity, etc. as the device information S₃₁. The battery 38 is, e.g., a lead-acid battery, a nickel-metal hydride battery, a lithium-ion battery, and a sodium-sulfur battery, etc. For the power receiving device 3a, e.g., plural batteries 38 may be included or the battery 38 may be removable.

When the received power P that the power receiving device 3 is allowed to receive is limited to not more than a specified value P_{Th} that is set in advance, the power reception control unit 35 generates an intensity signal S₂ₐ including information that the received power P is limited to not more than the specified value P_{Th}, and transmits it through the transmitting antenna unit 34. Based on the intensity signal S₂ₐ, the power transmission control unit 20 controls the power transmitting antenna unit 23 to transmit the power transfer signal S₁ which results in the received power P of not more than the specified value P_{Th}.

This power receiving device 3 is the radio wave protection-power receiving device 3b. The radio wave protection-power receiving device 3b outputs the intensity signal S₂ₐ to the power transmitting device 2 through the transmitting antenna unit 34 so that the intensity P_{I} of the received power P rectified from the power transfer signal S₁ is limited to not more than the specified value P_{Th}. Based on the received intensity signal S₂ₐ, the power transmitting device 2 transmits the power transfer signal S₁ which results in not more than the specified value P_{Th}. The power transmitting device 2 performs optimization by repeatedly communicating with the radio wave protection-power receiving device 3b and transmits an optimal power transfer signal S₁ to the radio wave protection-power receiving device 3b.

### Configuration of the Power Transmitting Device 2

As shown in FIG. 2, the power transmitting device 2 is generally composed of, e.g., the power transmission control unit 20, the phase unit 21, an amplifier unit 22, the power transmitting antenna unit 23, and the receiving antenna unit 24. By performing phase control, the power transmitting device 2 transmits power transfer signals S₁ that are respectively optimal for the power receiving device 3a and the radio wave protection-power receiving device 3b.

The power transmission control unit 20 is, e.g., a microcomputer composed of a CPU (Central Processing Unit) performing calculation and processing, etc., of the acquired data according to a stored program, and a RAM (Random Access Memory) and a ROM (Read Only Memory) as semiconductor memories, etc. The ROM stores, e.g., a program for operation of the power transmission control unit 20. The RAM is used as, e.g., a storage area to temporarily store calculation results, etc. The power transmission control unit 20 also has, inside thereof, a means to generate a clock signal and operates based on the clock signal.

The power transmission control unit 20 generates, e.g., a high-frequency power transmission signal S₂₀. For example, the phase unit 21 adjusts the phase of the power transmission signal S₂₀. For example, the amplifier unit 22 amplifies the power transmission signal S₂₀ and also removes unwanted frequency components such as noise from the power transmission signal S₂₀, and outputs the resulting signal to the power transmitting antenna unit 23.

The power transmitting antenna unit 23 transmits, e.g., the power transmission signal S₂₀ as the power transfer signal S₁. This power transmitting antenna unit 23 has a power transmitting antenna 23a which is a phased array antenna, as an example.

The receiving antenna unit 24 has, e.g., a receiving antenna 24a composed of microstrip antennas (planar antennas). The receiving antenna unit 24 receives the intensity signal S₂, the intensity signal S₂ₐ, and the device information S₃₁.

Based on the received intensity signal S₂, the power transmission control unit 20 performs beam steering to perform optimization of concentrating the power transfer signal S₁ onto the power receiving device 3a so that the received power P is maximized. Based on the received intensity signal S₂ₐ, the power transmission control unit 20 performs beam steering to result in the received power P of not more than the specified value P_{Th}, thereby optimizing the power transfer signal S₁ to be received by the radio wave protection-power receiving device 3b.

### Configuration of the Power Receiving Device 3

The power receiving device 3a is generally composed of the power receiving antenna unit 30, the rectifier unit 31, the monitoring unit 32, a power adjustment unit 33, the transmitting antenna unit 34, and the power reception control unit 35. Meanwhile, the radio wave protection-power receiving device 3b is generally composed of the power receiving antenna unit 30, the rectifier unit 31, the monitoring unit 32, the transmitting antenna unit 34, and the power reception control unit 35. The radio wave protection-power receiving device 3b may also include an electronic device 36 such as a battery 38.

The power receiving antenna unit 30 has, e.g., a power receiving antenna 30a composed of microstrip antennas. The power receiving antenna unit 30 receives the power transfer signal S₁ and outputs it to the rectifier unit 31 as AC input power Pᵢₙ.

The rectifier unit 31 converts the AC input power Pᵢₙ into the received power P, which is DC power, and outputs the received power P to the power adjustment unit 33.

The monitoring unit 32 constantly monitors the intensity P_{I} of the received power P, and outputs monitoring information S₃₀, which is information about the intensity P_{I}, to the power reception control unit 35. The monitoring unit 32 is composed of, e.g., an RF (Radio Frequency) detector or a Schottky barrier diode, etc. The power consumption of the monitoring unit 32 is about several μA, as an example. The response speed of the monitoring unit 32 is several μs to several ns, as an example. This power consumption and response speed are superior to, e.g., a case where a beacon signal is constantly output to the power transmitting device 2 to perform phase control, etc.

The power adjustment unit 33 includes a DC (Direct Current)—DC circuit, etc. that converts the received power P into a voltage suitable for driving the sensor device 37 or charging the battery 38, and generates and outputs a drive voltage V for driving the sensor device 37 and a charging current I for charging the battery 38 respectively to the sensor device 37 and the battery 38. The power adjustment unit 33 also acquires the device information S₃₁ about the sensor device 37 and the battery 38 and outputs it to the power reception control unit 35.

The transmitting antenna unit 34 has, e.g., a transmitting antenna 34a composed of microstrip antennas. The transmitting antenna unit 34 of the power receiving device 3a transmits the intensity signal S₂ and the device information S₃₁. The transmitting antenna unit 34 of the radio wave protection-power receiving device 3b transmits the intensity signal S₂ₐ.

The power reception control unit 35 is, e.g., a microcomputer composed of a CPU, a RAM, and a ROM, etc. The ROM stores, e.g., a program for operation of the power reception control unit 35. The RAM is used as, e.g., a storage area to temporarily store calculation results, etc. The power reception control unit 35 also has, inside thereof, a means to generate a clock signal and operates based on the clock signal.

The power reception control unit 35 of the power receiving device 3a controls the power receiving antenna unit 30, the rectifier unit 31, the monitoring unit 32, the power adjustment unit 33, and the transmitting antenna unit 34.

Meanwhile, the power reception control unit 35 of the radio wave protection-power receiving device 3b controls the power receiving antenna unit 30, the rectifier unit 31, the monitoring unit 32, and the transmitting antenna unit 34. The power reception control unit 35 of the radio wave protection-power receiving device 3b has the specified value P_{Th}, as shown in FIG. 2. This power reception control unit 35 transmits the intensity signal S₂ₐ to the power transmitting device 2 based on the monitoring information S₃₀ to cause the received power P to have the intensity P_{I} of not more than the specified value P_{Th}.

This specified value P_{Th} is set based on the power transfer signal S₁ acceptable for an object to be protected. When the object to be protected is a human body, the specified value P_{Th} is set to not more than a permissible level of radio waves to which the human body is exposed. Meanwhile, when the object to be protected is an electronic device, the specified value P_{Th} is set so that, e.g., interference of radio waves is suppressed when the electronic device is a wireless device that communicates with other devices. The specified value P_{Th} is also set to, e.g., the minimum value at which the intensity P_{I} of the received power P is detectable and transmission is possible.

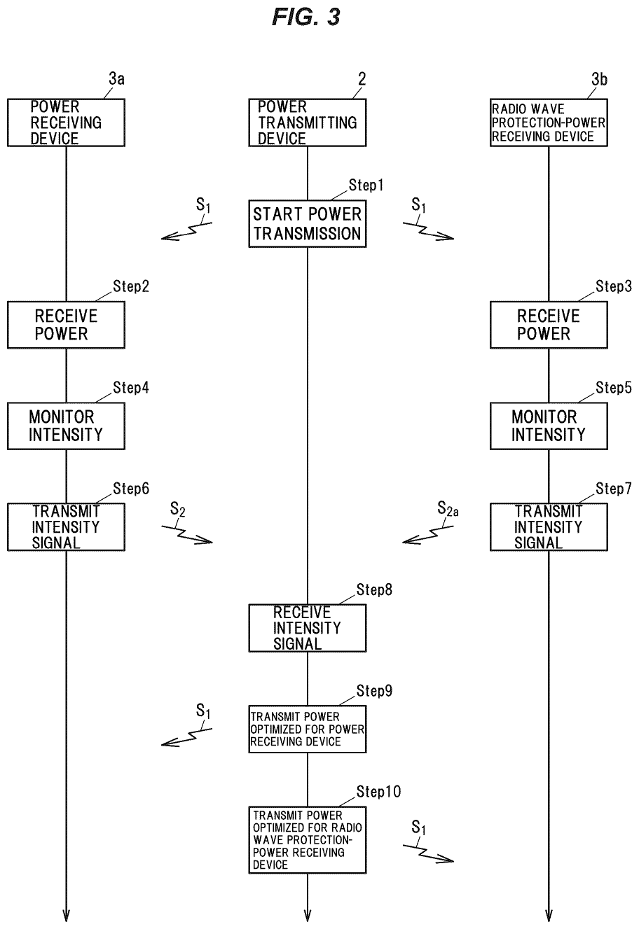

Next, an example operation of the wireless power supply system 1 in the present embodiment will be described with reference to the sequence diagram in FIG. 3.

### Operation

The power transmitting device 2 starts transmission of the power transfer signal S₁ (Step 1).

The power receiving device 3a receives the power transfer signal S₁ (Step 2). The radio wave protection-power receiving device 3b receives the power transfer signal S₁ (Step 3).

The power receiving device 3a monitors the intensity P_{I} of the received power P based on the received power transfer signal S₁ (Step 4). The radio wave protection-power receiving device 3b monitors the intensity P_{I} of the received power P based on the received power transfer signal S₁ (Step 5).

The power receiving device 3a transmits the intensity signal S₂ related to the intensity P_{I} of the received power P to the power transmitting device 2 (Step 6). The radio wave protection-power receiving device 3b transmits the intensity signal S₂ₐ related to the intensity P_{I} of the received power P to the power transmitting device 2 (Step 7).

The power transmitting device 2 receives the intensity signal S₂ from the power receiving device 3a and receives the intensity signal S₂ₐ from the radio wave protection-power receiving device 3b (Step 8).

The power transmitting device 2 transmits the power transfer signal S₁ optimized based on the intensity signal S₂ received from the power receiving device 3a (Step 9).

The power transmitting device 2 also transmits the power transfer signal S₁ optimized to result in not more than the specified value P_{Th} based on the intensity signal S₂ₐ received from the radio wave protection-power receiving device 3b (Step 10).

The wireless power supply system 1 repeats such communication between the power transmitting device 2 and the power receiving device 3a and between the power transmitting device 2 and the radio wave protection-power receiving device 3b, and transmits optimized power transfer signals S₁ to the power receiving device 3a and the radio wave protection-power receiving device 3b.

### Effects of the Embodiment

The wireless power supply system 1 in the present embodiment can optimize the power transfer signal at low cost. In particular, since the wireless power supply system 1 controls the phase based on the intensity P_{I} of the received power P, the power transfer signal S₁ can be optimized at lower cost than when this configuration is not adopted.

In the wireless power supply system 1, the density of power to be received by the power receiving device 3 is optimally controlled for each of the power receiving device 3a and the radio wave protection-power receiving device 3b. Therefore, it is possible to protect human body or to keep interference with other wireless devices by adjusting the intensity P1 to not more than specified value P_{Th}, as compared to when this configuration is not adopted.

In the wireless power supply system 1, the power transmitting antenna 23a of the power transmitting antenna unit 23 is a phased array antenna, which allows for beam focusing and construction of a highly efficient system with simple circuit design, as compared to when using other antennas.

When power is transmitted to the radio wave protection-power receiving device 3b, the wireless power supply system 1 optimizes the intensity P_{I} of the received power P to be not more than specified value P_{Th}. Therefore, the radio waves to which the human body is exposed can be limited to not greater than the acceptable level as compared to when this configuration is not adopted.

In the wireless power supply system 1, the monitoring unit 32 required to optimize the phase of the power transfer signal S₁ is composed of an RF detector or a Schottky barrier diode. Therefore, the response speed is faster and the power consumption can be suppressed, as compared to when this configuration is not adopted.

Although the embodiment of the invention has been described, the embodiment is merely an example and the invention according to claims is not to be limited thereto. This new embodiment may be implemented in various other forms, and various omissions, substitutions and changes, etc., can be made without departing from the gist of the invention. In addition, not all combinations of the features described in the embodiment are necessary to solve the problem of the invention. Further, this embodiment is included within the scope and gist of the invention and also within the invention described in the claims and the range of equivalency.

### REFERENCE SIGNS LIST

1 WIRELESS POWER SUPPLY SYSTEM
2 POWER TRANSMITTING DEVICE
3 POWER RECEIVING DEVICE
3a POWER RECEIVING DEVICE
3b RADIO WAVE PROTECTION-POWER RECEIVING DEVICE
20 POWER TRANSMISSION CONTROL UNIT
21 PHASE UNIT
22 AMPLIFIER UNIT
23 POWER TRANSMITTING ANTENNA UNIT
23a POWER TRANSMITTING ANTENNA
24 RECEIVING ANTENNA UNIT
24a RECEIVING ANTENNA
30 POWER RECEIVING ANTENNA UNIT
30a POWER RECEIVING ANTENNA
31 RECTIFIER UNIT
32 MONITORING UNIT
33 POWER ADJUSTMENT UNIT
34 TRANSMITTING ANTENNA UNIT
34a TRANSMITTING ANTENNA
35 POWER RECEPTION CONTROL UNIT
36 ELECTRONIC DEVICE
37 SENSOR DEVICE
38 BATTERY
I CHARGING CURRENT
P RECEIVED POWER
P_{I} INTENSITY
P_{Th} SPECIFIED VALUE
Pᵢₙ AC INPUT POWER
S₁ POWER TRANSFER SIGNAL
S₂ INTENSITY SIGNAL
S₂₀ POWER TRANSMISSION SIGNAL
S₂a INTENSITY SIGNAL
S₃₀ MONITORING INFORMATION
S₃₁ DEVICE INFORMATION
V DRIVE VOLTAGE

1. A wireless power supply system, comprising:
a power receiving device comprising a power receiving antenna unit that receives a power transfer signal, a rectifier unit that rectifies the power transfer signal into received power, a monitoring unit that monitors an intensity of the received power, a transmitting antenna unit that transmits an intensity signal related to the intensity of the received power, and a power reception control unit that controls the transmitting antenna unit based on a monitoring result of the monitoring unit to transmit the intensity signal; and
a power transmitting device comprising a power transmitting antenna unit that transmits the power transfer signal, a phase unit that adjusts a phase of the power transfer signal, a receiving antenna unit that receives the intensity signal, and a power transmission control unit that controls the phase unit based on the intensity signal and performs phase control of the power transfer signal so as to be optimal for the power receiving device.

2. The wireless power supply system according to claim 1, wherein the power reception control unit acquires device information related to an electrically connected electronic device and transmits the device information through the transmitting antenna unit, and wherein the power transmission control unit performs the phase control of the power transfer signal so as to be optimal for the power receiving device, based on the device information received through the receiving antenna unit.

3. The wireless power supply system according to claim 1, wherein when the received power that the power receiving device is allowed to receive is limited to not more than a specified value that is set in advance, the power reception control unit generates the intensity signal including information that the received power is limited to not more than the specified value, and transmits the intensity signal through the transmitting antenna unit, and wherein based on the intensity signal, the power transmission control unit controls the power transmitting antenna unit to transmit the power transfer signal that results in the received power of not more than the specified value.
